(19) United States
(12) Patent Application Publication
(10) Pub. No.: US 2013/0036002 A1
(43) Pub. Date: Feb. 7, 2013

(54) Web based system and method for conducting business

(71) Applicants: Nabil Hodroj, (US); David K. Chahine, (US)

(72) Inventors: Nabil Hodroj, (US); David K. Chahine, (US)

(21) Appl. No.: 13/137,264

(22) Filed: Aug. 2, 2011

(51) Int. Cl. G06Q 30/02

(52) U.S. Cl. 705/14.36

(57) ABSTRACT

The inventive concept of the web based system and method for conducting business (the system) an Internet platform that allows a seller to upload his/her materials, such as, for example, outlines and class notes. The seller may identify the outlines and noted by categorizing the same by college name and professor name and by a topic, such as math, history, algebra, etc. A buyer can locate the outlines and notes by a school or college, by the name of the professor and by the topics. The system allows the seller either scan the notes in a format that will allow the buyer to scan the entire document in search for specific words or use an option wherein the seller will index at least five words, i.e. search tags wherein the buyer will be able to search through in order to decide whether to purchase the outline or to continue searching for other products.

### FIELD OF THE INVENTION

The present invention relates to a system and method of selling a product, as well as sharing it by an Internet data communication system, and more particularly to a method of selling and sharing a product such as, for example, class documents, e-books, or magazines through the Internet where the content of the product is searchable by users.

### BACKGROUND OF THE INVENTION

Various traditional systems of sales of various products such as cloth, furniture, books, etc., to a large number of unspecified general consumers through the media of television, newspapers, magazines, etc. has had a large effect on the fortunes of the distribution system from the producers to the wholesalers and retailers. With invent of Internet data communication system over more than a decade ago, however, sales systems using the Internet much reported on by the mass media, for example, the sales systems effectively publicizing the sale of photographs, paintings, automobiles, etc. using the Internet, can be expected to grow along with the striking growth in the number of potential consumers as compared with conventional shopping systems using magazines and other recording media.

Numerous publications such as magazines, books, educational materials are produced and sold on a weekly and monthly basis. New magazines, books, educational materials are designed and developed on a regular basis to cater to ever changing tastes of readers and market trends. One of the most important markets is educational market that is replete with various educational materials used widely by students at different educational communities such as colleges, high schools, etc.

There has been significant success in producing audio versions of education materials. As mentioned earlier, technological advances have introduced new ways of making these educational materials available to students. Examples of such innovations are internet and electronic books, commonly referred to as e-books.

People use a variety of gadgets to access these online versions of magazines and books. Alternately, electronic versions of books and magazines are also available. E-books may require specific hardware and software to access and read a desired book or magazine. Apart from accessing magazines and books online, multiple methods of transferring these electronic versions of books and magazines have been developed. Examples of such technologies are e-mail, download, streaming, podcasting, auto-casting, and audio blogging. Audible.com is a successful website where numerous books are available in audio mode. Also available at audible.com are audio versions of private material.

However, the current approaches suffer from one deficiency. Current publishers of magazines offer either printed or online electronic educational materials in part or in entirety from one source at a time. Students with their hectic live schedule, look for ways to use their time efficiently to accomplish more including reading magazines, may it be to quench their thirst for knowledge or for recreation. Students are looking for ways to obtain quality study guides for low price and with quality content.

There a need for a new system and method adaptable to allow the student to benefit financially from the product of creation. There is a need for a new system and method that will encourage each student to collect notes from the class that the student attends and customize the notes into an outline. There is also a longstanding need for a unique marketplace for those looking to obtain class notes and outlines from a particular professor and/or for a particular class taught at a particular college that the user is seeking to purchase wherein this new system will replace provide a low cost and effective alternative to expensive books and publications such as commercial outlines that not every student can afford to purchase.

### SUMMARY OF THE INVENTION

The inventive concept of the web based system and method for conducting business (the system) an Internet platform that allows a seller to upload his/her materials, such as, for example, outlines and/or class notes. The seller may identify the outlines and noted by categorizing the same by the name of the college, the department of interest, the professor of interest, and finally the class that this professor is teaching, such as Math-1234 taught by professor John Smith at the University of Alabama. A buyer can locate the outlines and notes by in a particular school, by the name of the college, the department of interest, the professor of interest, and the class that this professor is teaching. The system allows the seller either scan the notes in a format that will allow the buyer to scan the entire document in search for specific words or use the option wherein the seller will index at least five words representing the main highlights of the document, i.e. search tags wherein the buyer will be able to search through in order to decide whether to purchase the outline/document or to continue searching for other products.

This web-based system will introduce and implement a new type of money-exchanging method between users of the system. The prices of the products being listed as well as the payment method will not use direct money exchange. The system implements a unique method wherein a personalized currency made exclusively for the use of the users on the system. The unit of currency utilized will have a specific monetary value that is set and governed by the the system. The users of the system can only utilize one type of currency in transactions between users. Whether they are pricing their product before selling it or buying a product with a specific price, they will have use the mentioned above payment method.

Welcoming users to utilize this e-commerce web-based system and try its features is the main goal behind the personalized payment method, without creating a load of costs on the system. The above-mentioned currency will have two versions: version A or a first version and version B or a second version. Version A currency will be a purchasable form of currency, to be utilized in the system. Version B currency will not be purchasable; rather, it will be a form of currency granted to new users as the new users will join the system. Both versions are of the same value, if used by a user to buy any product in the system.

Anytime a buyer makes a purchase, a certain amount of currency, that is equivalent to the price of the product being purchased (whether Version A or B) will be withdrawn from the buyer's account. On the other hand, the seller will receive only the version A currency that were involved in that particular transaction. For instance, the buyer wants to purchase an item, such as an outline, that is priced at 5 units of currency (regardless whether Version A or B, since they are of the same value to make purchases). Assuming that the buyer has 3 units of Version A and 2 units of Version B with a total of 5 units, which is enough to purchase that item. Upon purchasing, the buyer will lose 3 units of Version A currency and 2 units of Version B currency. However, the seller will gain the total of Version A units used in the purchase but zero units of Version B. That is, the seller will receive 3 units of Version A currency added to her/his account. This will minimize the costs on the system as well as give new users a form of free trial but with more organization and easier/sophisticated way of gathering statistical data. In addition, any system that utilizes this form of invention can always apply a minimum fee as a percentage to the Version A units that a seller receives with every transaction.

An advantage of the present invention is to provide the system and method adaptable to allow the student to benefit financially from the product of creation.

Another advantage of the present invention is to provide the system that will encourage each student to collect notes from the class that the student attends and customize the notes into the outline that will be posted for sale or the exchange thereby generating additional income. Nevertheless, the seller always has the right to post her/his products for free, that is without expecting a return.

Still another advantage of the present invention is to provide a unique marketplace for those looking to obtain class notes and outlines for a particular professor and for a particular class taught at a particular college that the user is seeking to purchase in preparation of any upcoming class, or in choosing classes with a particular teaching style, etc.

Still another advantage of the present invention is to provide a low cost and effective alternative to expensive books and publications such as commercial outlines that not every student can afford to purchase.

Other advantages and meritorious features of this invention will be more fully understood from the following description of the preferred embodiment, the appended claims, and the drawings; a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a schematic view of operational components of the present inventive system.

FIG. 2 illustrates a schematic flow chart of steps taken by a user/seller as the user/seller logs in to a system to post his/her materials for sale and/or exchange;

FIG. 3 a schematic flow chart of steps taken by a user/buyers the user/buyer logs in to a system to purchase materials available for sale and/or exchange;

FIG. 4 illustrates additional schematic view flow chart of steps taken by a user/buyer as the user/buyer logs in to a system to purchase materials available for sale and/or exchange; and

FIG. 5 illustrates a schematic view of operational components of the present inventive system as shown in FIG. 1 with a virtual currency component operably connected thereto.

### DETAILED DESCRIPTION OF THE PREFERRED EMBODIMENT

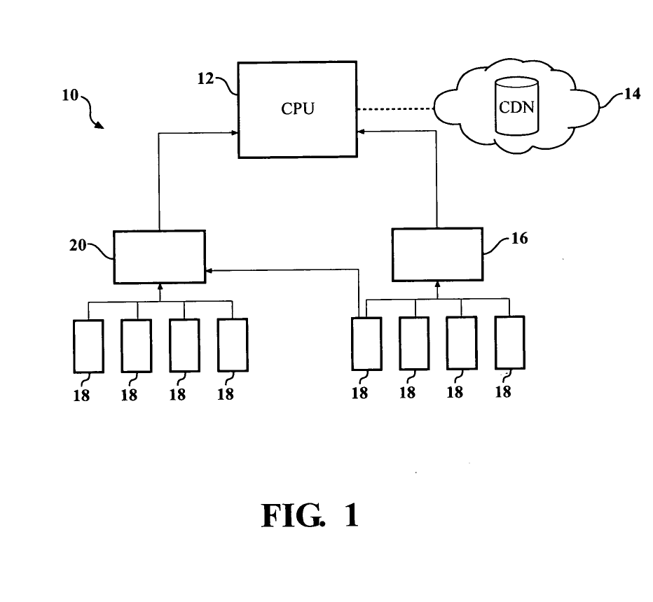

Referring to the Figures, wherein numerals indicate like or corresponding parts, an inventive system and method for conducting business (the system) an Internet platform that allows a seller to upload his/her materials, such as, for example, outlines and class notes (the system) is generally shown at 10 in FIG. 1. The system 10 provides a unique method to allow students (also referred further below as users, sellers, and buyers) 18 to benefit financially from the product of his/her creation, such as class notes, outlines that each student 18 composes at the lectures. The system 10 includes a controller (CPU) 12, a content delivery network (CDN) 14, a buyer interface module 16, a seller interface module 20. Both the buyer interface module 16 and the seller interface module 20 are operably communicated by the CPU 12 and each adaptable to receive and process information from the users 18, wherein each user may be either a seller, a buyer or both.

The system 10 and method of the present invention encourages each student 18 to collect notes from the class that the student 18 attends and customize the notes into the outline. The system 10 also provides a unique marketplace for those looking to obtain class notes and outlines from a particular professor and for a particular class taught at a particular college that the user is seeking to purchase wherein this new system will replace provide a low cost and effective alternative to expensive books and publications such as commercial outlines that not every student can afford to purchase.

The inventive concept of the system 10 allows the seller 18 may identify the outlines and noted by categorizing the same by college name and professor name and by a topic, such as math, history, algebra, etc. The buyer 18 can locate the outlines and notes by a school or college, by the name of the professor and by the topics. The system 10 allows the seller 18 either to scan the notes in a format that will allow the buyer 18 to scan the entire document in search for specific words or use an option wherein the seller 18 will index at least five words, i.e. search tags wherein the buyer 18 will be able to search through in order to decide whether to purchase the outline or to continue searching for other products.

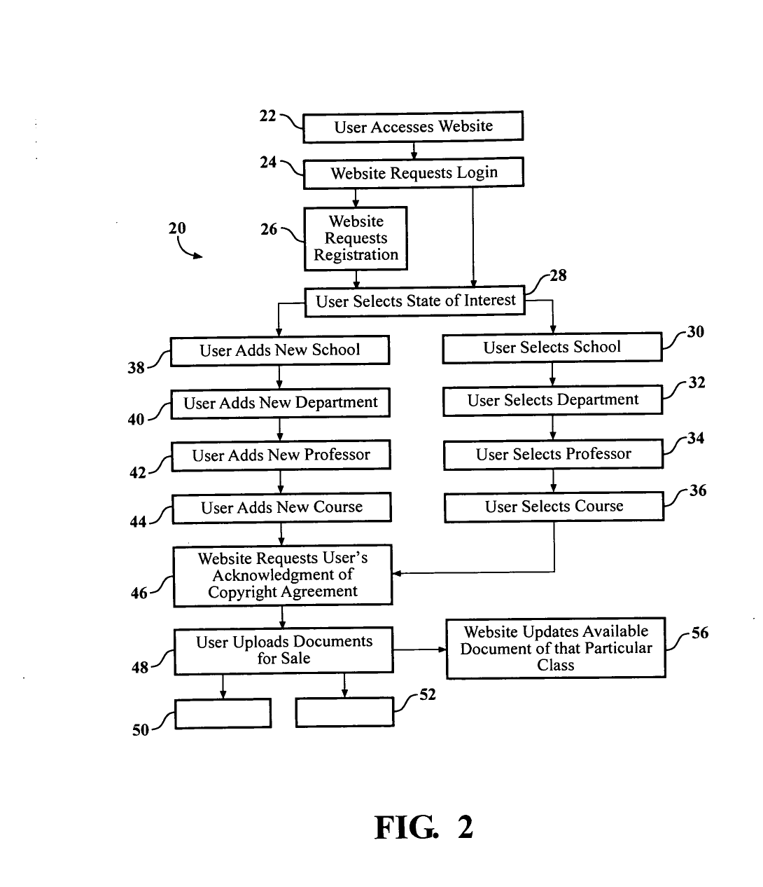

Referring now to FIG. 2, a schematic flow chart of steps taken by the user/seller 18 as the user/seller 18 logs in to the system 10 to post his/her materials for sale and/or exchange is generally shown at 20. As the user 18 accesses a website 22, the user/seller 18 will be required to register with the website 24. The registration process will require the user 18 to complete 26 such field as name, gender, name of school, college, or any other educational institution. The user 18 will be required to provide his/her bank account to wire money from in order to initiate a purchase and to receive funds after the item is sold to the buyers 18. The user 18 will be required to select 28 a state where the user's educational institution is located. The user 18 will be required to indicate the name of the educational institution 30, the name of the department 32, and the name of the professor.

The system 10 includes a database of all educational institutions, all departments, and name of the professors. Alternatively, if any particular school, college, or name of the department and the name of the professor is not listed in the database, the user/seller 18 may create such new field listing the missing names by sending a request to a host and administrative support of the system 10. These new fields will be created after the verification is complete.

For example, if the user/seller 18 wants to sell or exchange his/her class notes from State University, a college of engineering, a department of mechanical engineering, and a basics of mechanical engineering taught by a professor John Smith, the user/sell, after logging into the system 10 and providing the required information, the user 18 will input “State University”, “Department of Mechanical Engineering”, “John Smith”, and “Basics of mechanical engineering” at the respective steps 30, 32, 34 and 36, and shown in FIG. 2.

Alluding to the above, the user/seller 18 has an option to log in to the system 10 again any time the user/seller 18 wants to add new information. For example, the user/seller 18 completed his/her two years at the State University and transferred to State College. The user/seller 18 takes additional classes and is looking to sell or exchange his/her outlines and class notes. The user/seller 18 is enrolled at a college of chemical engineering, a department of organic chemistry, and takes a class of nanotechnology taught by a professor J. R. John. The user/seller 18 will log in back to the system 10 to provide updated information, thereby adding name of a new educational institution 38, a name of a new department 40, a name of a new professor 42, a name of a new course 44. The user/seller will input “State College”, “Department of Organic Chemistry”, “J. R. John”, and “Nanotechnology” at the respective steps 38, 40, 42 and 44, as shown in FIG. 2.

As shown at 46 in FIG. 2, the user/seller 18 will be required to electronically confirm that all materials provided by the user/seller 18 are not in violation of copyright laws and are products of labor of the user/seller. After the confirmation is complete, the user/sell 18 will upload the documents 48 for sale or exchange. The user/seller 18 will have the following two options that the system 10 provides an option to upload 50 the documents in a pdf format, word format, or other electronic formats without limiting the scope of the present invention. Regardless if the document is uploaded 50 in a version that can be search through “find it” or “word search” process, the user/seller is provided with “tag it” section/option 52. Here, the user/seller will be allowed to provide the system 10 with at least ten terms/words used in the document. The user/buyer will be able to search the documents by the words that the user/seller identified in the “tag it” section 52. This option will be very helpful for those users/sellers who prefer to take hand notes and even if scanned, these notes cannot be searched through searching options provided by MS Word formats and pdf formats. Those skilled in the art will appreciate that the number of words that the user/seller is allowed to select for “tag it” section 52 is not intended to limit the scope of the present invention. After the documents are uploaded, the system 10 will update 56 all uploaded documents thereby making the same available for sale and exchange.

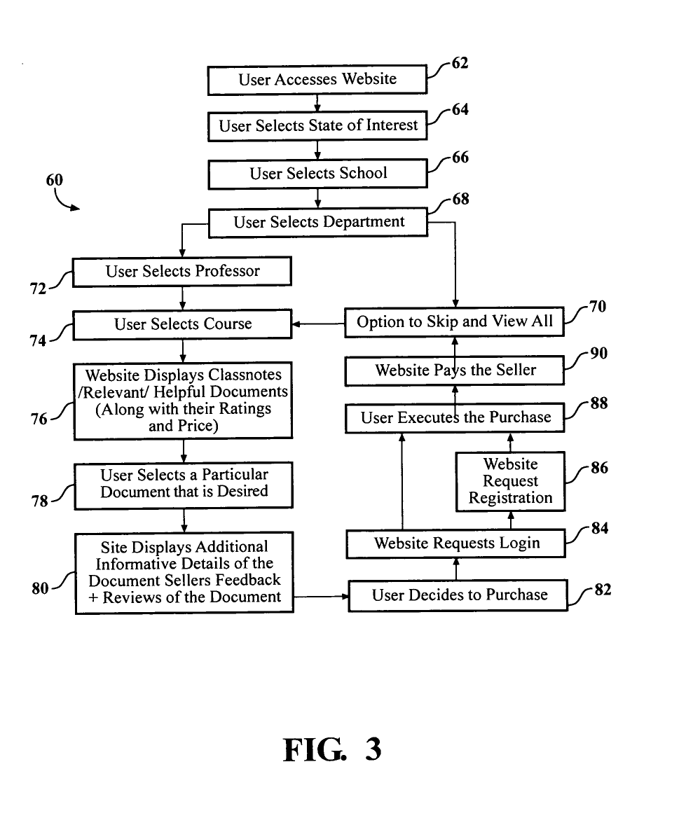

Referring now to FIG. 3, a schematic flow chart of steps taken by a user/buyer as the user/buyer logs in to the system 10 to purchase materials available for sale and/or exchange, is generally shown at 60. As the user 18 accesses a website 62, the user/seller 18 may be required to register with the website. The registration process will require the user to complete such field as name, gender, name of school, college, or any other educational institution. The user will be required to register with services such as PayPal or other financial institutions in order to wire money from in order to initiate a purchase and to receive funds after the item is sold to the buyers. The user 18 will be required to select 64 a state where the user's educational institution is located. The user 18 will be required to indicate the name of the educational institution 66, the name of the department 68, and the name of the professor 72. The user/buyer 18 may have an option where all of the above steps of selection may be skipped 70 and the user/buyer 18 may go directly to select 74 the course that the user/buyer 18 is interested to obtain the class notes of outlines.

For example, the user/buyer 18 is looking enroll into the State College and study chemistry. The user/buyer 18 is looking to obtain any materials available for classes related to nanotechnology and taught by any professor at the State College or by the professor J. R. John. The user/seller 18 will input the following information such as “State College”, “Department of Organic Chemistry”, “J. R. John”, and “Nanotechnology” in the respective fields 64 through 74. After the selection is made, the system 10 will display all class notes and other related documents 76 for the user/buyer 18 to make a choice. The user/buyer 18 then selects 78 a particular document that is desired to be exchanged or purchased. The system 10 will display 80 any additional information available for the particular document. For example, this information may include any feedback that the particular user/seller 18 received from other users/buyers 18 and any reviews of the document provided by other users/buyers 18.

After the user/buyer 18 read all information and by using the “tag it” section 52 did scan the documents and searched through searching options provided by MS Word formats and pdf formats, the user/buyer 18 made a decision to purchase 82 the document. The system 10 will request the user/buyer 18 to log in to the system 10 by verifying personal information the user/buyer 18. The registration requirements 86 for the user/buyer 18 may be provided at any time while the user/buyer 18 using the system 10. After the user/buyer 18 purchased the document 88, the system 10 will transfer the funds to the user/seller 18 account.

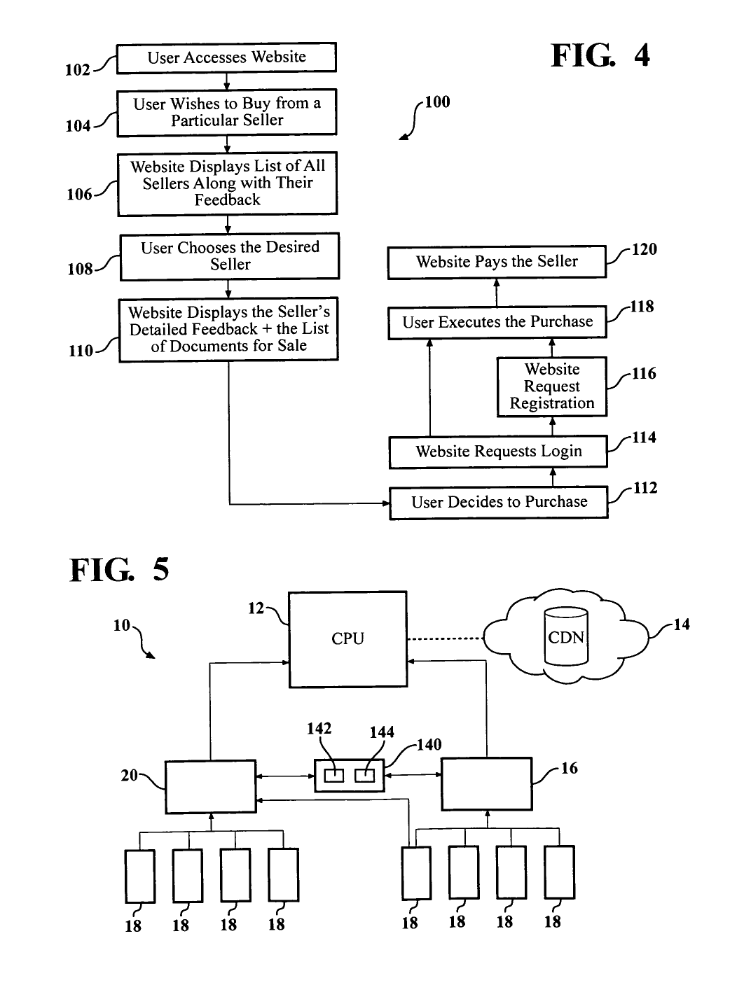

FIG. 4 illustrates additional schematic view of the flow chart of steps taken by the user/buyer 18, generally shown at 100, wherein the user/buyer 18 logs in to the system 10 to purchase materials available for sale and/or exchange form. For example, the user/buyer 18 has previously purchased materials from a particular user/seller 18 and wishes to obtain other materials from the same user/seller 18. The typical scenario will be where students who just enrolled into the college are looking is looking enroll into classes and would like to obtain feedback from other who took the same classes taught by the same professor or certain style of teaching and did well in those classes. For example if one student purchased outlines from a particular user/seller 18 and liked the content and if the user/seller 18 took the same professor as the user/buyer 18 is looking to take, the user/buyer 18 may wish to stick with a particular seller.

Referring back to FIG. 4, will log in 102 to the system 10 and will locate the particular seller's portal 104 by search in the log in name of the seller 18. The portal or webpage will display 106 list of all sellers, if the user/seller 15 particular name is unknown, or the web page of the particular seller 18 with all feedback and comments about the particular seller 18. The user/buyer 18 will choose 108 the desired user/seller 18. The system 10 will display 110 the detailed information about the user/seller 18 and the list of the documents available for sale. The system 10 will request the user/buyer 18 to log in 114 to the system 10 by verifying personal information the user/buyer 18. The registration requirements 116 for the user/buyer 18 may be provided at any time while the user/buyer 18 using the system 10. After the user/buyer 18 purchased the document 118, the system 10 will transfer 120 the funds to the user/seller 18 account.

Referring now to FIG. 5, the system 10 will introduce and implement a new type of money-exchanging method between users of the system 10. As best shown in FIG. 5, both the buyer interface module 16 and the seller interface module 20 are operably communicated with a unit 140 for generating virtual currency for the users 18. The unit 140 is operably communicated with the CPU 12. The unit 140 includes a first software 142 adaptable for receiving information from the users 18 and adaptable to generate, track and issue a version A currency (to be discussed further). The unit 140 includes a second software 144 adaptable for receiving information from the users 18 and adaptable to generate, track and issue a version B currency (to be discussed further).

Alluding to the above, the prices of the products being listed as well as the payment method will not use direct money exchange. The system 10 implements a unique method wherein a personalized currency made exclusively for the use of the users on the system 10. The unit of currency utilized will have a specific monetary value that is set and governed by the system 10. The users 18 of the system 10 can only utilize one type of currency in transactions between users 18. Whether they are pricing their product before selling it or buying a product with a specific price, they will have use the mentioned above payment method.

Welcoming users 18 to utilize this e-commerce web-based system and try its features is the main goal behind the personalized payment method, without creating a load of costs on the system 10. The above-mentioned currency will have two versions: the version A or a first version and the version B or a second version. Version A currency will be a purchasable form of currency, to be utilized in the system 10. Version B currency will not be purchasable; rather, it will be a form of currency granted to new users 18 as the new users 18 will join the system 10. Both versions are of the same value, if used by a user 18 to buy any product in the system 10.

Anytime a buyer 18 makes a purchase, a certain amount of currency, that is equivalent to the price of the product being purchased (whether Version A or B) will be withdrawn from the buyer's account. On the other hand, the seller 18 will receive only the version A currency that were involved in that particular transaction. For instance, the buyer 18 wants to purchase an item, such as an outline, that is priced at 5 units of currency (regardless whether Version A or B, since they are of the same value to make purchases). Assuming that the buyer 18 has 3 units of Version A and 2 units of Version B with a total of 5 units, which is enough to purchase that item. Upon purchasing, the buyer 18 will lose 3 units of Version A currency and 2 units of Version B currency.

However, the seller 18 will gain the total of Version A units used in the purchase but zero units of Version B. That is, the seller 18 will receive 3 units of Version A currency added to her/his account. This will minimize the costs on the system 10 as well as give new users a form of free trial but with more organization and easier/sophisticated way of gathering statistical data. In addition, any system that utilizes this form of invention can always apply a minimum fee as a percentage to the Version A units that a seller 18 receives with every transaction.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A system for selling and sharing a product through Internet between the users subscribing to said system from communication devices, said system comprising:
a first device accessible by a user for receiving information from the user and saving the information in a format adaptable to be scanned and uploaded by another user with said first device having a database of questions to be answered by the users to create profile of each user interested to exchange the information;
a second device accessible by the user for receiving information from the user in order to locate the information stored in said first device with said second device haying a database of questions to be answered by the users to create profile of each user interested to acquire the information;
a central processing unit operably communicated with said first device and said second device; and
a controller of said system adaptable to facilitate acquisition of the information uploaded by one of the users to be acquired by another user with said controller adaptable to process currency received from the user that acquires the information and transferring the currency to the user that downloaded the information through said first device whereby said controller is configured to generate a first type of said currency awarded to the user as the user logs in to said second device and a second type of the currency to be purchased by the user whereby the amount to be transferred to the user will include a combination of the first and second type of said currency with the user purchasing the information will redeem the amount of said currency of the first type and the user selling the information receives the amount of said currency of the second type wherein said currency of the first type is not purchasable by the user and is presented in a form of currency granted to the new users as the new user registers with said system through said second device and said currency of the second type is a purchasable form of currency exchanged for a monetary value.

2. A system as set forth in claim 1, wherein the information is further defined by documents containing notes.

3. (canceled)

4. A system as set forth in claim 1, wherein said communication device includes at least one of a desktop computer, a laptop computer, a mobile phone, and a smart phone.

5. A system as set forth in claim 1, wherein said controller includes a first software adaptable for receiving information from the user and adaptable to generate, track and issue said currency of the first type.

6. A system as set forth in claim 1, wherein said controller includes a second software adaptable for receiving information from the user and adaptable to generate, track and issue said currency of the second type.

7. A system as set forth in claim 1, wherein the users are connected with each other through said system by a network including at least one of a wired network, a wireless network, and a fiber network.

8. (canceled)

9. (canceled)

10. (canceled)

11. (canceled)
